(19) United States
(12) Patent Application Publication
(10) Pub. No.: US 2025/0246914 A1
(43) Pub. Date: Jul. 31, 2025

(54) MULTI-TIME SCALE VOLTAGE CONTROL METHOD FOR ACTIVE DISTRIBUTION NETWORK

(71) Applicants: NANJING UNIVERSITY OF POSTS AND TELECOMMUNICATIONS, Nanjing, Jiangsu (CN); STATE GRID ELECTRIC POWER RESEARCH INSTITUTE CO., LTD., Nanjing, Jiangsu (CN)

(72) Inventors: Dong YUE, Nanjing, Jiangsu (CN); Siqi LIU, Nanjing, Jiangsu (CN); Chunxia DOU, Nanjing, Jiangsu (CN); Zhijun ZHANG, Nanjing, Jiangsu (CN); Xiaohua DING, Nanjing, Jiangsu (CN); Jingtao ZHAO, Nanjing, Jiangsu (CN); Shu ZHENG, Nanjing, Jiangsu (CN); Kun HUANG, Nanjing, Jiangsu (CN)

(73) Assignees: NANJING UNIVERSITY OF POSTS AND TELECOMMUNICATIONS, Nanjing, Jiangsu (CN); STATE GRID ELECTRIC POWER RESEARCH INSTITUTE CO., LTD., Nanjing, Jiangsu (CN)

(21) Appl. No.: 18/847,260

(22) PCT Filed: Oct. 19, 2022
(86) PCT No.: PCT/CN2022/126084

§ 371 Date: Sep. 15, 2024

(30) Foreign Application Priority Data
Mar. 21, 2022 (CN) 202210274867.0

(51) Int. Cl. H02J 3/46; H02J 3/16

(52) U.S. Cl. CPC H02J 3/46; H02J 3/16

(57) ABSTRACT

A multi-time scale voltage control method for an active distribution network is provided. The method comprises: establishing a voltage optimization approach taking into account a large scale of distributed power supplies to realize cooperative dynamic control in case of a voltage violation generated when the distributed power supplies are incorporated into a distribution network; under a long time scale, establishing a voltage control model for controlling a capacitor bank based on voltage sensitivity analysis to realize drastic voltage regulation in case of the voltage violation by means of reactive power compensation; and under a short time scale, establishing a distributed voltage control model, and considering the problem of voltage violation, solving an optimal control strategy online by fully using active and reactive power outputs of the distributed power supplies to realize quick voltage regulation.

### FIELD

The invention belongs to the field of voltage control of distribution networks, and particularly relates to a multi-time scale voltage control method for an active distribution network.

### BACKGROUND

Distributed power supplies, as clean energy, witness a rapid development in recent years, and by the end of 2020, the gross installed capacity of photovoltaics has reached about 253,000,000 kW, and the gross installed capacity of wind generators has reached about 281,000,000 kW. A large proportion of distributed power supplies are accessed to distribution networks because of their advantages of energy saving, environmental protection and flexible operation control, and can better control the power quantity of the distribution networks and improve power supply safety and reliability. As a result, the access of a large number of distributed energy resources to power distribution networks becomes an irreversible situation. However, after a large proportion of distributed power supplies are accessed to a distribution network by means of power electronic devices, the distribution network will be changed into an active network allowing power to flow bidirectionally, which will not only generate a series of harmonic waves, but also will lead to voltage violation problems of access points such as voltage fluctuations, flickers and sags, thus compromising safe and stable operation of lines and directly affecting the consumption capacity of the distribution network to distributed power supplies and the operating efficiency of the distributed power supplies. Voltage control can reduce voltage fluctuations by some necessary means to stabilize the voltage within a safety margin, thus being an important aspect of self-healing control of distribution networks.

In existing study, measures adopted to solve the voltage violation problems of a distribution network where distributed power supplies are accessed without changing the existing network structure of the distribution network mainly include adjustment of taps of on-load tap changing transformers, restriction on the active power, and installation of reactive control devices such as a capacitor bank and an electric reactor, and control based on smart inverters. Deep study is carried out in active and reactive voltage control, power control and performance control of various devices and systems at home and abroad. Under the high infiltration of distributed power supplies, grid-connection indicators are higher, random small disturbance is more frequent, system modeling requirements are higher, and system modeling is more complex.

### SUMMARY

In view of the voltage violation problems of access points such as voltage fluctuations, flickers and sags caused by the access of distributed power supplies to a distribution network, the invention provides a multi-time scale voltage control method for an active distribution network, which realizes real-time voltage control by controlling active and reactive power outputs of distributed power supplies to maintain the voltage within a safety range, thus guaranteeing the stability and safety of a bus.

To solve the above technical problems, the invention adopts the following technical solution:

A multi-time scale voltage control method for an active distribution network comprises:

calculating the sensitivity to a reactive power of a voltage of each power injection node of an active distribution network, and determining a configuration node and a configuration capacity of a capacitor bank based on the calculated sensitivity to the reactive power of the voltage;
acquiring a distribution network voltage control model in which distributed power supplies and the capacitor bank participate, which is established with a minimum voltage violation of the nodes as an objective function;
under a long time scale, converting the distribution network voltage control model in which the distributed power supplies and the capacitor bank participate into a voltage control model for controlling the capacitor bank based on the capacity of the capacitor bank on the configuration node, and solving the voltage control model for controlling the capacitor bank to obtain an optimal voltage control strategy; and
under a short time scale, converting the distribution network voltage control model in which the distributed power supplies and the capacitor bank participate into a voltage control model for controlling power outputs of the distributed power supplies, and solving the voltage control model for controlling the power outputs of the distributed power supplies to obtain an optimal voltage control strategy.

Further, the sensitivity to the reactive power of the voltage of each power injection node of the active distribution network is calculated as follows:
assume the network has S slack nodes and N power injection bus nodes, for power injection disturbance of each individual node, set powers of other loads/generators are not changed, and a relationship between an injected power and the voltages of the nodes is as follows:

$$\begin{matrix}\underline{{S}_{i}} = \underline{{E}_{i}} {\sum }_{j ∈ S ⋃ N} \overline{{Y}_{ij} {E}_{j}} , & i ∈ N\end{matrix} \qquad ( 3 )$$

where, E̅ⱼ̅ is the voltage of a j^{th} node, Eᵢ is a conjugate vector of E̅ᵢ̅, E̅ᵢ̅ is the voltage of an i^{th} node, Sᵢ is a conjugate vector of Sᵢ, Sᵢ is an apparent power of the i^{th} node, and Y̅ᵢ̅ⱼ̅ is an admittance of the i^{th} node and the j^{th} node;
a slack bus satisfies:

$$\begin{matrix}\frac{\partial \overline{{E}_{1}}}{\partial {Q}_{l}} = 0 , & ∀ i ∈ S\end{matrix} \qquad ( 4 )$$

where, Qₗ is an active power of an l^{th} node,

$$\frac{\partial \overline{{E}_{i}}}{\partial {Q}_{l}}$$

is a partial derivative of the voltage of the i^{th} node with respect to a reactive power of the l^{th} node, and l=1, 2, . . . , N;
according to

$$\frac{\partial \underline{{S}_{i}}}{\partial {Q}_{l}} = \frac{\partial \{ {P}_{i} - {jQ}_{l} \}}{\partial {Q}_{l}} = - j {1}_{\{ i = 1 \}} ,$$

the partial derivative of the bus voltage with respect to the reactive power satisfies the following equations:

$$\begin{matrix}- j {1}_{\{ i = 1 \}} = \frac{\partial \underline{{E}_{i}}}{\partial {Q}_{l}} {\sum }_{j ∈ S ⋃ N} \overline{{Y}_{ij} {E}_{j}} + \underline{{E}_{i}} {\sum }_{j = N} \overline{{Y}_{ij}} \frac{\partial \overline{{E}_{j}}}{\partial {Q}_{l}} & i ∈ N\end{matrix} \qquad ( 5 )$$

where, Pᵢ and Qᵢ are respectively an active power and a reactive power fed to the i^{th} node; when i=l, the right of the equation is −j; when i≠l, the right of the equation is 0;
after

$$\frac{\partial \overline{{E}_{i}}}{\partial {Q}_{l}} and \frac{\partial \underline{{E}_{i}}}{\partial {Q}_{l}}$$

are obtained by calculation according to formula (4) and formula (5), the sensitivity to the reactive power of the voltage is finally calculated according to the following formula:

$$\begin{matrix}\frac{\partial \vert \overline{{E}_{i}} \vert}{\partial {Q}_{l}} = \frac{1}{\vert \overline{{E}_{i}} \vert} Re ( \underline{{E}_{i}} \frac{\partial \overline{{E}_{i}}}{\partial {Q}_{l}} ) & i ∈ N\end{matrix} \qquad ( 6 )$$

Further, determining a configuration node and a configuration capacity of a capacitor bank based on the calculated sensitivity to the reactive power of the voltage comprises:
selecting the node with a maximum sensitivity to the reactive power as the configuration node of the capacitor bank, and calculating the capacity of the capacitor bank according to the following formula:

$$Δ {Q}_{k} = [ \vert Δ {V}_{1 , max} \vert , \vert Δ {V}_{2 , max} \vert , ⋯ , \vert Δ {V}_{N , max} \vert ] \cdot [ \begin{matrix}\frac{\partial {Q}_{k}}{\partial {V}_{1}} \\ \frac{\partial {Q}_{k}}{\partial {V}_{2}} \\ ⋮ \\ \frac{\partial {Q}_{k}}{\partial {V}_{N}}\end{matrix} ] \qquad ( 7 )$$

where, ΔQₖ is the capacity of the capacitor bank on the configuration node k; |ΔV_{i,max}| is a historical maximum voltage violation of the i^{th} node, and i=1, 2, . . . , N;

$$\frac{\partial {Q}_{k}}{\partial {V}_{i}}$$

is a reciprocal of the sensitivity to a reactive power of the node k of the voltage of the i^{th} node.

Further, the objective function of the distribution network voltage control model in which the distributed power supplies and the capacitor bank participate is:

$$min F ( x ) = \{ \begin{matrix}{\sum }_{i = 1}^{n} ( {U}_{i} - 1.05 {U}_{N} ) , & {U}_{i} \geq 1.05 {U}_{N} \\ {\sum }_{i = 1}^{n} ( 0.95 {U}_{N} - {U}_{i} ) , & {U}_{i} \leq 0.95 {U}_{N}\end{matrix} \qquad ( 8 )$$

where, Uᵢ is the node voltage of an i^{th} node, U_{N} is a rated voltage of the distribution network, n is the number of power injection nodes, and a maximum safety range of the node voltage is ±5%;
constraints are:

$$\{ \begin{matrix}{\sum }_{i = 1}^{n} {P}_{t , i , l} + {P}_{t , loss} = {P}_{t , M} + {P}_{t , G} \\ {\sum }_{i = 1}^{n} {Q}_{t , i , l} + {Q}_{t , loss} = {Q}_{t , M} + {Q}_{t , G} + {Q}_{t , CB}\end{matrix} \qquad ( 9 )$$

$$\{ \begin{matrix}{U}_{i , min} \leq {U}_{i} \leq {U}_{i , max} \\ \vert \frac{{U}_{i} - {U}_{N}}{{U}_{N}} \vert \leq 5 \%\end{matrix} \qquad ( 10 )$$

$$\{ \begin{matrix}{P}_{i} = {P}_{Gi} - {P}_{li} \\ {Q}_{i} = {Q}_{Gi} - {Q}_{li} \\ {P}_{i , min} \leq {P}_{i} \leq {P}_{i , max} \\ {Q}_{i , min} \leq {Q}_{i} \leq {Q}_{i , max}\end{matrix} \qquad ( 11 )$$

$$\{ \begin{matrix}{P}_{Gi , min} \leq {P}_{Gi} \leq {P}_{Gi , max} \\ {Q}_{Gi , min} \leq {Q}_{Gi} \leq {Q}_{Gi , max}\end{matrix} \qquad ( 12 )$$

where, formula (9) is a power flow constraint, P_{t,i,l} and Q_{t,i,l} are respectively an active power and a reactive power of the i^{th} node at a time t, P_{t,loss} and Q_{t,loss} are respectively an active loss and a reactive loss of a distribution network line at the time t, P_{t,M} and Q_{t,M} are respectively an active power and a reactive power output by a main network at the time t, P_{t,G} and Q_{t,G} are respectively an active power and a reactive power output by the distributed power supplies at the time t, and Q_{t,CB} is a reactive power output by the capacitor bank at the time t; formula (10) is a node voltage constraint, U_{i,min} and U_{i,max} are respectively a maximum voltage and a minimum voltage of the i^{th} node, and Uᵢ and U_{N} are respectively the voltage of the i^{th} node and a rated voltage of the distribution network; formula (11) is a node power constraint, Pᵢ and Qᵢ are respectively an active power and a reactive power fed to the i^{th} node, Pᵢ and Q_{Gi} are respectively an active power output and a reactive power output of the distributed power supply incorporate to the i^{th} node, Pₗᵢ and Qₗᵢ are respectively load powers on the i^{th} node, and P_{i,min}, P_{i,max}, Q_{i,min} and Q_{i,max} are respectively a minimum active power, a maximum active power, a minimum reactive power and a maximum reactive power of the i^{th} node; formula (12) is a power output constraint of the distributed power supplies, and P_{Gi,min}, P_{Gi,max}, Q_{Gi,min} and Q_{Gi,max} are respectively a minimum active power output, a maximum active power output, a minimum reactive power output and a maximum reactive power output of the distributed power supply incorporate to the i^{th} node.

Further, converting the distribution network voltage control model in which the distributed power supplies and the capacitor bank participate into a voltage control model for controlling the capacitor bank based on the capacity of the capacitor bank on the configuration node comprises:
defining a state space as a set of a current voltage, active power and reactive power of each power injection node;
determining a compensation quantity of the parallel capacitor bank on the configuration node according to the capacity of the capacitor bank, and setting an action space as the compensation quantity of the parallel capacitor bank on the configuration node; and
setting a reward function as the sum of a quadratic form of a voltage violation of each node and the compensation quantity of the capacitor bank.

Further, the state space is:

$$s : \{ {v}_{1} , … , {v}_{i} , … , {v}_{n} , {p}_{1} , … , {p}_{i} , … , {p}_{n} , {q}_{1} , … , {q}_{i} , … , {q}_{n} \} \qquad ( 13 )$$

where, vᵢ, pᵢ and qᵢ are respectively an observed voltage, active power and reactive power of an i^{th} node, i=1, 2, . . . , n, and n is the total number of the power injection nodes;
a multi-stage capacitor bank is adopted, the obtained capacity of the capacitor bank is taken as a maximum compensation quantity, and the capacity of each stage is taken as a set value of the action space:

$$A = \{ {CB}_{max} , {CB}_{max} / 2 , 0 , - {CB}_{max} / 2 , {CB}_{max} \} \qquad ( 14 )$$

where, CB max is the maximum compensation quantity of the capacitor bank;
the reward function is:

$$Reward = - [ Δ {v}_{1} , … , Δ {v}_{i} , … , Δ {v}_{n} ] {Q [ Δ {v}_{1} , … , Δ {v}_{i} , … , Δ {v}_{n} ]}^{T} - {Ra}_{k} \qquad ( 15 )$$

where, Δvᵢ is the voltage violation of the i^{th} node, aₖ is the compensation quantity of the capacitor bank on the configuration node k, Q and R are a weight matrix and a weight coefficient, and Δvᵢ is specifically:

$$Δ {v}_{i} = \{ \begin{matrix}{v}_{i} - {v}_{n} \times 5 \% , & {v}_{i} > ( 1 + 5 \% ) {v}_{n} \\ {v}_{n} \times 95 \% - {v}_{i} , & {v}_{i} < ( 1 - 5 \% ) {v}_{n}\end{matrix} \} \qquad ( 16 )$$

where, a selected voltage violation safety range is 5%.

Further, solving the voltage control model for controlling the capacitor bank to obtain an optimal voltage control strategy comprises:
Step a1: initializing a memory, initializing a weight parameter of a Q network to ω, initializing a weight parameter of target Q network ω′=ω, and taking the current voltage, active power and reactive power of each node as an initial state s;
Step a2: generating and performing an action a∈A according to a greedy strategy, and obtaining a reward r and a new state s′ by formula (15);
Step a3: saving a transition sample (s,a,r,s′) in the memory, and randomly selecting a minibatch of samples (sᵢ,aᵢ,rᵢ,sᵢ′) from the memory;
Step a4: setting

$$TargetQ = {r}_{i} + γ {max}_{{a}^{′}} Q ( {s}^{′} , {a}^{′} ; {ω}^{′} ) ,$$

and calculating a loss function according to the following formula:

$$L ( θ ) = E [ {( TargetQ - Q ( s , α ; ω ) )}^{2} ] \qquad ( 17 )$$

where, E(⋅) is a desired value, TargetQ is a target value of the target network, Q(s,a;ω) is a predicted value of the action a adopted in the state s when the weight parameter is ω, and γ is a discount factor;
Step a5: updating the weight parameter of the target Q network ω′=ω by a gradient descent method; and
Step a6: repeating Step a2 to Step a5 until iteration is ended to obtain the optimal voltage control strategy.

Further, converting the distribution network voltage control model in which the distributed power supplies and the capacitor bank participate into a voltage control model for controlling power outputs of the distributed power supplies comprises:

setting a state space as a current voltage, active power and reactive power of each power injection node; setting an action space as an active power output variation and a reactive power output variation of the distributed power supply incorporated into each node; setting a reward function as the sum of a quadratic form of a voltage violation of each node and a control quantity of the distributed power supply, and setting reactive weight coefficients to be greater than active weight coefficients.

Further, the action space is the active power output variation AP and the reactive power output variation ΔQ of the distributed power supply incorporated into each node, ΔP∈[P_{i,max}−P_{Gi}, P_{i,min}−P_{Gi}], and ΔQ=[Q_{i,max}−Q_{Gi}>Q_{Gi}−Q_{i,min}], where i=1, 2, . . . , n; P_{i,min}, P_{i,max}, Q_{i,min}, and Q_{i,max} are respectively a minimum active power, a maximum active power, a minimum reactive power and a maximum reactive power of an i^{th} node; P_{Gi} and Q_{Gi} are respectively an active power output and a reactive power output of the distributed power supply incorporated into the i^{th} node;
the reward function is:

$$Reward = - [ Δ {v}_{1} , … , Δ {v}_{i} , … , Δ {v}_{n} ] {Q [ Δ {v}_{1} , … , Δ {v}_{i} , … , Δ {v}_{n} ]}^{T} - [ {p}_{1} , … , {p}_{i} , … , {p}_{n} ] {R [ {p}_{1} , … , {p}_{i} , … , {p}_{n} ]}^{T} - [ {q}_{1} , … , {q}_{i} , … , {q}_{n} ] {J [ {q}_{1} , … , {q}_{i} , … , {q}_{n} ]}^{T} \qquad ( 18 )$$

where, Δvᵢ is the voltage violation of the i^{th} node, pᵢ is the active power output of the distributed power supply incorporated into the i^{th} node, qᵢ is the active power output of the distributed power supply incorporated into the i^{th} node, and Q, R and J are weight matrixes.

Further, solving the voltage control model for controlling the power outputs of the distributed power supplies to obtain an optimal voltage control strategy comprises:
Step b1: initializing parameters of main networks and target networks, initializing a memory, and taking a current voltage, active power and reactive power of each node as an initial state;
Step b2: selecting an action according to a behavioral strategy, issuing the action to an environment to be performed, and obtaining a reward and a new state according to formula (18);
Step b3: saving a state transition process obtained in Step b2 in the memory, and randomly sampling transition data from the memory as training data of a strategy main network and an evaluation main network;
Step b4: updating parameters of the evaluation main network by a gradient descent method, and softupdating the parameters of the main target networks to the target networks by a runningaverage method; and
Step b5: repeating Step b2 to Step b4 until iteration is ended to obtain the optimal voltage control strategy.

Compared with the prior art, the invention fulfills the following beneficial effects:

According to the multi-time scale voltage control method for an active distribution network provided by the invention, global voltage information can be sensed without the coordination of center nodes, temporal and spatial distribution characteristics of node voltages of the distribution network are analyzed based on power flow sensitivity analysis, the configuration node and configuration capacity of a capacitor bank are determined, and a control model comprising a large scale of distributed power supplies and the capacitor bank and realizing synchronous output of the active power and reactive power is constructed; in the invention, voltage control based on reactive power compensation takes precedence over voltage control based on active power reduction, such that the economic cost is reduced, and the economy is improved; moreover, voltage control under a long time scale and voltage control under a short time scale are comprehensively considered in the invention, power output by distributed power supplies is fully used, and it is ensured that the voltage can be controlled flexibly and quickly in case of instable power output of the distributed power supplies; and a DRL algorithm is adopted to effectively solve the problem of high dimensionality of the network, and the action of the distribution network can be adjusted in real time according to the current state of the distribution network, and the dynamic response performance is good.

### BRIEF DESCRIPTION OF THE DRAWINGS

FIG. 1 is a flow diagram according to one embodiment of the invention;

FIG. 2 is a topological diagram of an active power distribution network according to one embodiment of the invention;

FIG. 3 is a schematic diagram of the amplitude of voltage of nodes before a control method is adopted according to one embodiment of the invention;

FIG. 4 is a schematic diagram of a DQN training result of a test platform according to one embodiment of the invention;

FIG. 5 is a schematic diagram of a DDPG training result of the test platform according to one embodiment of the invention;

FIG. 6 is a schematic diagram of the voltage of nodes after a control algorithm is adopted for the test platform according to one embodiment of the invention;

FIG. 7 is a schematic diagram of the variation of the active power after the control algorithm is adopted for the test platform according to one embodiment of the invention;

FIG. 8 is a schematic diagram of the variation of the reactive power after the control algorithm is adopted for the test platform according to one embodiment of the invention.

### DETAILED DESCRIPTION

The invention is further described below in conjunction with specific embodiments. The following embodiments are merely used for more clearly explaining the technical solution of the invention and should not be construed as limitations of the protection scope of the invention.

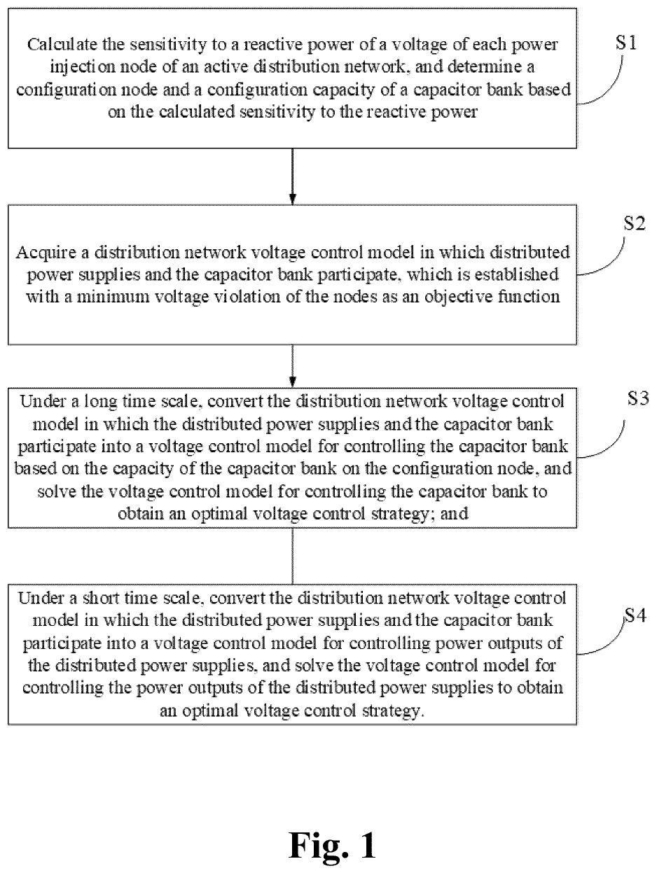

The embodiments of the invention provide a multi-time scale voltage control method for an active distribution network. As shown in FIG. 1, the multi-time scale voltage control method for an active distribution network specifically comprises the following steps:
Step 1, the sensitivity to a reactive power of a voltage of each power injection node of an active distribution network is calculated, and a configuration node and a configuration capacity of a capacitor bank are determined based on the calculated sensitivity to the reactive power of the voltage.

According to line parameters between the nodes and an injected power, the sensitivity to an injected reactive power of a voltage of each power supply node is calculated specifically as follows:
Step 1-1: an equation of a bus voltage and a corresponding injected current is listed:

$$[ \overline{I} ] = [ \overline{Y} ] \cdot [ \overline{E} ] \qquad ( 1 )$$

where, [Ī]=[I̅₁̅], I̅₂̅, . . . , I̅ₖ̅, . . . , I̅_̅{̅M̅}̅]^{T} is the injected current, [Ē]=[E̅₁̅], E̅₂̅, . . . E̅ₖ̅, . . . , E̅_̅{̅M̅}̅]^{T} is the bus voltage, M is the total number of nodes of the distribution network, and [Y̅] is a compound admittance matrix and is expressed as follows:

$$[ \overline{Y} ] = [ \begin{matrix}\overline{{Y}_{11}} & \overline{{Y}_{21}} & … & \overline{{Y}_{k 1}} & … & \overline{{Y}_{M 1}} \\ \overline{{Y}_{12}} & \overline{{Y}_{22}} & … & \overline{{Y}_{k 2}} & … & \overline{{Y}_{M 2}} \\ ⋮ & ⋮ & ⋱ & ⋮ & ⋱ & ⋮ \\ \overline{{Y}_{1 k}} & \overline{{Y}_{2 k}} & … & \overline{{Y}_{kk}} & … & \overline{{Y}_{Mk}} \\ ⋮ & ⋮ & ⋱ & ⋮ & ⋱ & ⋮ \\ \overline{{Y}_{1 M}} & \overline{{Y}_{2 M}} & … & \overline{{Y}_{kM}} & … & \overline{{Y}_{MM}}\end{matrix} ] \qquad ( 2 )$$

where, Y̅ᵢ̅ⱼ̅ indicates an admittance of an i^{th} node and a j^{th} node, and i, j∈[1, 2, . . . , k, . . . . M].
Step 1-2: assume the network has S slack nodes and N power injection bus nodes (power injection is considered as constant and independent of voltage), for power injection disturbance of each individual node, set powers of other loads/generators are not changed, and a relationship between the injected power and the voltages of the nodes is as follows:

$$\underline{{S}_{i}} = \underline{{E}_{i}} {\sum }_{j ∈ S ⋃ N} \overline{{Y}_{ij} {E}_{j}} , i ∈ N \qquad ( 3 )$$

where, E̅ⱼ̅ is the voltage of a j^{th} node, Eᵢ is a conjugate vector of E̅ᵢ̅, E̅ᵢ̅ is the voltage of an i^{th} node, Sᵢ is a conjugate vector of Sᵢ, S̅ᵢ̅ is an apparent power of the i^{th} node, and Y̅ᵢ̅ⱼ̅, is an admittance of the i^{th} node and the j̅^̅{̅t̅h̅}̅ node; because the voltage of a relax bus is kept constant and is equal to a rated voltage of the network and the phase of the relax bus is zero, the relax bus satisfies:

$$\frac{\partial \overline{{E}_{i}}}{\partial {Q}_{l}} = 0 , ∀ i ∈ S \qquad ( 4 )$$

where, Qₗ is an active power of an l^{th} node, ∂E̅ᵢ̅/∂Qₗ is a partial derivative of the voltage of the i^{th} node with respect to a reactive power of the l^{th} node, and l=1, 2, . . . , N;
according to

$$\frac{\partial \underline{{S}_{i}}}{\partial {Q}_{l}} = \frac{\partial \{ {P}_{i} - {jQ}_{i} \}}{\partial {Q}_{l}} = - j {1}_{\{ i = l \}} ,$$

the partial derivative of the voltage with respect to the reactive power satisfies the following equations:

$$- j {1}_{\{ i = l \}} = \frac{\partial \underline{{E}_{i}}}{\partial {Q}_{l}} {\sum }_{j ∈ S ⋃ N} \overline{{Y}_{ij} {E}_{j}} + \underline{{E}_{i}} {\sum }_{j = N} \overline{{Y}_{ij}} \frac{\partial \overline{{E}_{j}}}{\partial {Q}_{l}} i ∈ N \qquad ( 5 )$$

where, Pᵢ and Qᵢ are respectively an active power and a reactive power fed to the i^{th} node; when i=l, the right of the equation is −j; when i≠1, the right of the equation is 0.
Step 1-3: after

$$\frac{\partial \overline{{E}_{i}}}{\partial {Q}_{l}} and \frac{\partial \underline{{E}_{i}}}{\partial {Q}_{l}}$$

are obtained by calculation according to formula (4) and formula (5), the sensitivity to the reactive power of the voltage is obtained finally according to the following formula:

$$\frac{\partial \vert \overline{{E}_{i}} \vert}{\partial {Q}_{l}} = \frac{1}{\vert \overline{{E}_{i}} \vert} Re ( \underline{{E}_{i}} \frac{\partial \overline{{E}_{i}}}{\partial {Q}_{l}} ) i ∈ N \qquad ( 6 )$$

Step 1-4: after the voltage sensitivity of each node is calculated according to the above, the configuration node of the capacitor bank is selected according to the voltage sensitivities. In the invention, the node with a maximum voltage sensitivity is selected as the configuration node of the capacitor bank, and the capacity of the capacitor bank is calculated according to the following formula:

$$Δ {Q}_{k} = [ \vert Δ {V}_{1 , max} \vert , \vert Δ {V}_{2 , max} \vert , … , \vert Δ {V}_{n , max} \vert ] \cdot [ \begin{matrix}\frac{\partial {Q}_{k}}{\partial {V}_{1}} \\ \frac{\partial {Q}_{k}}{\partial {V}_{2}} \\ ⋮ \\ \frac{\partial {Q}_{k}}{\partial {V}_{n}}\end{matrix} ] \qquad ( 7 )$$

where, ΔQₖ is the capacity of the capacitor bank on the configuration node k; |ΔV_{i,max}| is a historical maximum voltage violation of the i^{th} node, and i=1, 2, . . . , N;

$$\frac{\partial {Q}_{k}}{\partial {V}_{i}}$$

is a reciprocal of the sensitivity to the reactive power of the node k of the voltage of the i^{th} node.
Step 2, a distribution network voltage control model in which distributed power supplies and the capacitor bank participate and which is established with a minimum voltage violation of the nodes as an objective function is acquired.

A voltage control optimization strategy model for incorporating the distributed power supplies to the distribution network is constructed with the minimum voltage violation of the nodes as the objective function:

$$min F ( x ) = \{ \begin{matrix}{\sum }_{i = 1}^{n} ( {U}_{i} - 1.05 {U}_{N} ) , & {U}_{i} \geq 1.05 {U}_{N} \\ {\sum }_{i = 1}^{n} ( 0.95 {U}_{N} - {U}_{i} ) , & {U}_{i} \leq 0.95 {U}_{N}\end{matrix} \qquad ( 8 )$$

where, Uᵢ is a node voltage of the i^{th} node, U_{N} is a rated voltage of the distribution network, n is the number of power injection nodes, and a maximum safety range of the node voltage is ±5%.

Specific constraints are as follows:

$$\{ \begin{matrix}{\sum }_{i = 1}^{n} {P}_{t , i , l} + {P}_{t , loss} = {P}_{t , M} + {P}_{t , G} \\ {\sum }_{i = 1}^{n} {Q}_{t , i , l} + {Q}_{t , loss} = {Q}_{t , M} + {Q}_{t , G} + {Q}_{t , CB}\end{matrix} \qquad ( 9 )$$

$$\{ \begin{matrix}{U}_{i , min} \leq {U}_{i} \leq {U}_{i , max} \\ \vert \frac{{U}_{i} - {U}_{N}}{{U}_{N}} \vert \leq 5 \%\end{matrix} \qquad ( 10 )$$

$$\{ \begin{matrix}{P}_{i} = {P}_{Gi} - {P}_{li} \\ {Q}_{i} = {Q}_{Gi} - {Q}_{li} \\ {P}_{i , min} \leq {P}_{i} \leq {P}_{i , max} \\ {Q}_{i , min} \leq {Q}_{i} \leq {Q}_{i , max}\end{matrix} \qquad ( 11 )$$

$$\{ \begin{matrix}{P}_{Gi , min} \leq {P}_{Gi} \leq {P}_{Gi , max} \\ {Q}_{Gi , min} \leq {Q}_{Gi} \leq {Q}_{Gi , max}\end{matrix} \qquad ( 12 )$$

where, formula (9) is a power flow constraint, P_{t,i,l} and Q_{t,i,l} are respectively an active power and a reactive power consumed by a load I on the i^{th} node at a time t, P_{t,loss} and Q_{t,loss} are respectively an active loss and a reactive loss of a distribution network line at the time t, P_{t,M} and Q_{t,M} are respectively an active power and a reactive power output by a main network at the time t, P_{t,G} and Q_{t,G} are respectively an active power and a reactive power output by the distributed power supplies at the time t, and Q_{t,CB} is a reactive power output by the capacitor bank at the time t; formula (10) is a node voltage constraint, U_{i,min} and U_{i,max} are respectively a maximum voltage and a minimum voltage of the i^{th} node, and Uᵢ and U_{N} are respectively the voltage of the i^{th} node i and the rated voltage of the distribution network; formula (11) is a node power constraint, Pᵢ and Qᵢ are respectively an active power and a reactive power fed to the i^{th} node, P_{Gi} and Q_{Gi} are respectively an active power output and a reactive power output of the distributed power supply incorporated into the i^{th} node, PH and Qui are respectively load powers on the i^{th} node, and P_{i,min}, P_{i,max}, Q_{i,min} and Q_{i,max} are respectively a minimum active power, a maximum active power, a minimum reactive power and a maximum reactive power of the i^{th} node; formula (12) is a power output constraint of the distributed power supplies, and P_{Gi,min}, P_{Gi,max}, Q_{Gi,min} and Q_{Gi,max} are respectively a minimum active power output, a maximum active power output, a minimum reactive power output and a maximum reactive power output of the distributed power supply incorporated into the i^{th} node.
Step 3, under a long time scale, the distribution network voltage control model in which the distributed power supplies and the capacitor bank participate is converted into a voltage control model for controlling the capacitor bank based on the capacity of the capacitor bank on the configuration node, and solving the voltage control model for controlling the capacitor bank to obtain an optimal voltage control strategy.

The DNQ algorithm combines Q-learning with a neural network; in case of too many states and actions, if each value function is solved one by one, the efficiency will be extremely low; the use of the neural network to fit the value functions can effectively solve the problem of small space and increase the solving speed. A state is input to the neural network, an action is output by the neural network, DQN outputs the action by a greedy strategy after a value function is worked out by the neural network, an environment will provide a reward and a next state when receiving the action, and up to now, one step is completed. At this moment, parameters of a value function network are updated according to the reward, and then the next step is performed until an optimal value function network is obtained by training.

In each step, when the neural network approximates the value function, the value function is updated, that is, a weight parameter θ of the value function in each layer of the neural network is updated, and a loss function which represents a mean square error loss by the weight parameter θ is defined:

$$L ( θ ) = E [ {( TargetQ - Q ( s , a ; θ ) )}^{2} ]$$

where, E(⋅) is a desired value, TargetQ is a target value of a target network, and Q(s,a;θ) is a predicted value of an action a adopted in a state s when the weight parameter is θ (an output value of the neural network).

The neural network updates the parameter by a gradient descent method which is expressed as:

$${θ}_{t + 1} = {θ}_{t} + α [ r + γ {max}_{{a}^{′}} Q ( {s}^{′} , {a}^{′} ; θ ) - Q ( s , a , θ ) ] ∇ Q ( s , a ; θ )$$

where, ∇ is a gradient, θₜ and θₜ₊₁ are respectively parameters of the neural network at a time t and a time t+1, α is a step length, r is an obtained reward, γ is a discount factor, Q(s,a,θ) is a predicted value of the action a adopted in the state s when the weight parameter is θ, and

$$r + γ {max}_{{a}^{′}} Q ( {s}^{′} , {a}^{′} ; θ )$$

is a target Q network. The target network is used for calculating a target value to solve the problem that the parameter fails to converge due to the update of the target value every time the value function of the neural network is updated. Moreover, every time the parameter is updated, the DQN will use experience reply, that is, the DQN uses a piece of stored experience data, and one part of data will be sampled from Memory to update and break the relationship between data.

Assume the active distribution network has n power injection nodes and the voltage, active power and reactive power of each node are taken as controlled objects of the invention, a state space is set as a set of the current voltage, active power and reactive power of the n nodes, that is:

$$s : \{ {v}_{1} , … , {v}_{i} , … , {v}_{n} , {p}_{1} , … , {p}_{i} , … , {p}_{n} , {q}_{1} , … , {q}_{i} , … , {q}_{n} \} \qquad ( 13 )$$

where, vᵢ, pᵢ and qᵢ are respectively an observed voltage, active power and reactive power of the i^{th} node, i=1, 2, . . . , n, and n is the total number of the power injection nodes.
an action space is set as a compensation quantity of the parallel capacitor bank on the configuration node k. In this embodiment, a multi-stage capacitor bank is adopted, so the capacity of the capacitor bank calculated in Step 1 is set as a maximum compensation quantity, and the capacity of each stage is a set value of the action space:

$$A = \{ {CB}_{max} , \frac{{CB}_{max}}{2} , 0 , - \frac{{CB}_{max}}{2} , {CB}_{max} \} \qquad ( 14 )$$

where, CBₘₐₓ is the maximum compensation quantity of the capacitor bank.

In Step 2, the control objective is to minimize the node voltage offset, so a reward function is set as the sum of a quadratic form of the voltage violation of each node and the compensation quantity of the capacitor bank, that is:

$$Reward = - [ Δ {v}_{1} , … , Δ {v}_{i} , … , Δ {v}_{n} ] {Q [ Δ {v}_{1} , … , Δ {v}_{i} , … , Δ {v}_{n} ]}^{T} - {Ra}_{k} \qquad ( 15 )$$

where, Δvᵢ is the voltage violation of the i^{th} node, aₖ is the compensation quantity of the capacitor bank on the configuration node k, and Q and R are a weight matrix and a weight coefficient. Δvᵢ is specifically:

$$Δ {v}_{i} = \{ \begin{matrix}{v}_{i} - {v}_{n} \times 5 \% , & {v}_{i} > ( 1 + 5 \% ) {v}_{n} \\ {v}_{n} \times 95 \% - {v}_{i} , & {v}_{i} < ( 1 - 5 \% ) {v}_{n}\end{matrix} \} \qquad ( 16 )$$

where, Δvᵢ is the voltage violation of the i^{th} node, and in this embedment, a selected voltage violation safety range is 5%,
Based on the above state space, action space and reward function, the voltage control model for controlling the capacitor bank is solved by the DQN algorithm to obtain an optimal voltage control strategy. Specifically:
Step 3-1, a memory D is initialized, the weight parameter of a Q network is initialized to ω, the weight parameter of the target Q network is initialized to ω′=ω, and the voltage violations of the nodes are taken as an initial state s.
Step 3-2, an action a∈A is generated and performed according to the greedy strategy, and a reward r and a new state s′ are obtained by formula (15).
Step 3-3, a transition sample (s,a,r,s′) is saved in the memory, and a minibatch of samples (sᵢ, aᵢ,rᵢ, sᵢ) are randomly selected from the memory.
Step 3-4,

$$TargetQ = {r}_{i} + γ {max}_{{a}^{′}} Q ( {s}^{′} , {a}^{′} ; {ω}^{′} ) ,$$

and a loss function is calculated according to the following formula:

$$L ( θ ) = E [ {( TargetQ - Q ( s , a ; ω ) )}^{2} ] \qquad ( 17 )$$

where, E(⋅) is a desired value, TargetQ is a target value of the target network, Q(s,a;ω) is a predicted value of the action a adopted in the state s when the weight parameter is ω, and γ is a discount factor.
Step 3-5, every set steps, the weight parameter of the target Q network is updated ω′=ω.
Step 3-6, Step a2 to Step a5 are repeated until iteration is ended, and an optimal strategy is trained by an intelligent agent.
Step 4, under a short time scale, the distribution network voltage control model in which the distributed power supplies and the capacitor bank participate is converted into a voltage control model for controlling power outputs of the distributed power supplies, and the voltage control model for controlling the power outputs of the distributed power supplies is solved to obtain an optimal voltage control strategy.

The DDPG algorithm simulates a strategy function and a Q function by means of a convolutional neural network, and a maximum reward is obtained by exploration and learning of an intelligent agent in the environment. After the state space, the action space and the reward function are set, an action-value architecture is adopted, the neural network is used for approximately representing an evaluation main network and an evaluation target network by parameters θ_{M}^{c} and θ_{T}^{c}, and representing a strategy main network and strategy target network by parameters θ_{M}^{μ} and θ_{T}^{μ}. The objective of the evaluation main network is to maximize a desired reward, and the objective of the strategy main network is to minimize the loss function. For a state sₜ, an action aₜ is obtained by the strategy main network, a reward and a next state sₜ₊₁ are returned, {sₜ, aₜ, rₜ, sₜ₊₁} is saved in the memory D, m samples are uniformly sampled from D, and parameters of the strategy target network and the evaluation target network are updated according to the following formula to obtain optimal θ_{M,t}^{c} and θ_{M,t}^{μ}:

$$\{ \begin{matrix}{θ}_{T , t}^{c} = η {θ}_{M , t}^{c} + ( 1 - η ) {θ}_{T , t - 1}^{c} \\ {θ}_{T , t}^{μ} = η {θ}_{M , t}^{μ} + ( 1 - η ) {θ}_{T , t - 1}^{μ}\end{matrix}$$

where, η is a divergence factor, 0<η<1; θ_{T,t-1}^{c} and θ_{T,t-1}^{μ} are respectively the parameters of the strategy target network and the evaluation target network.

The current voltage, active power and reactive power of each node are defined as a state space.

Because the DDPG algorithm is used for a continuous action space, power output variations ΔP and ΔQ of the distributed power supplies incorporated into the nodes are designed into an action set, and upper and lower limits of the power output variations can be obtained according to formula (12). The value of AP is selected form a set [P_{i,max}−P_{Gi}, P_{i,min}−P_{Gi}], and the value of ΔQ is selected form a set [Q_{i,max}−Q_{Gi}, Q_{Gi}−Q_{i,min}].

The DDPG algorithm controls the power output of the distributed power supply on each node, so the reward function is set as the sum of the quadratic form of a voltage offset of each node and a control quantity of the distributed power supply. Because reactive power compensation takes precedence over active power reduction, reactive weight coefficients are set to be greater than active weight coefficients, that is:

$$( 18 )$$

$$Reward = - [ Δ {v}_{1} , … , Δ {v}_{i} , … , Δ {v}_{n} ] \text{} {Q [ Δ {v}_{1} , … , Δ {v}_{i} , … , Δ {v}_{n} ]}^{T} - [ {p}_{1} , … , {p}_{i} , … , {p}_{n} ] {R [ {p}_{1} , … , {p}_{i} , … , {p}_{n} ]}^{T} - [ {q}_{1} , … , {q}_{i} , … , {q}_{n} ] {J [ {q}_{1} , … , {q}_{i} , … , {q}_{n} ]}^{T}$$

where, Δvᵢ is the voltage violation of the i^{th} node, pᵢ is an active power output of the distributed power supply incorporated into the i^{th} node, qᵢ is a reactive power output of the distributed power supply incorporated into the i^{th} node, and Q, R and J are weight matrixes.

Based on the above state space, action space and reward function, the voltage control model for controlling the power outputs of the distributed power supplies is solved by the DDPG algorithm to obtain an optimal voltage control strategy. Specifically:
Step 4-1: the parameters of the main networks and the target networks are initialized, the memory is initialized, and the node voltage state and power output state are observed to initialize the state space.
Step 4-2: an action is selected according to a behavioral strategy and is issued to the environment to be performed, and a reward and a new state are obtained according to formula (18).
Step 4-3: a state transition process obtained in Step 4-2 is saved in the memory, and transition data is randomly sampled from the memory to be used as training data of the strategy main network and the evaluation main network.
Step 4-4: the parameters of the evaluation main network are updated by a gradient descent method, and the parameters of the main networks are softupdated to the target networks by a runningaverage method.
Step 4-5: Step 4-2 to Step 4-4 are repeated until iteration is ended, and an optimal strategy is trained by the intelligent agent.

To verify the effect of the invention, the embodiments of the invention provide the following test;

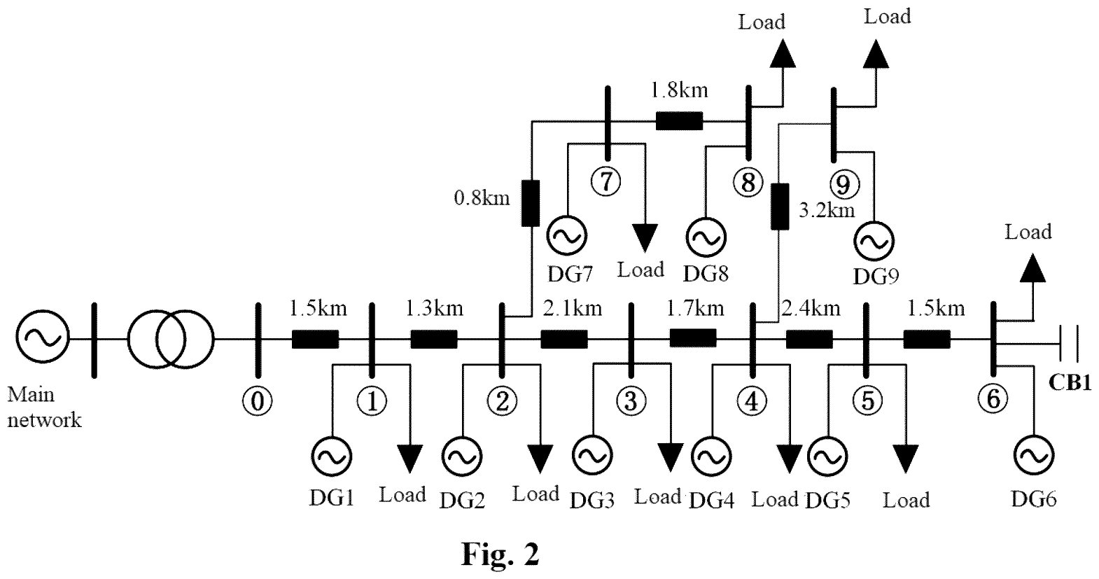

FIG. 2 is a topological diagram of an active distribution network according to one embodiment of the invention, wherein the rated voltage of the active distribution network is set to 10 KV, the active distribution network has nine power injection bus nodes, each node is connected to a distributed power supply and a load, each distributed power supply is accessed to the distribution network by means of an inverter with a rated power of 3 KW, the impedance of a distributed power transmission line is 0.096+j0.064 Ω/km, and simulated parameters of a system are shown in Table 1 and Table 2.

TABLE 1

| | | | Unit | Distance |
|---|---|---|---|---|
| Branch | Initial | Terminal | resistance/ | between nodes |
| number | node | node | (Ω/km) | (km) |
| 1 | 0 | 1 | 0.096 + j0.064 | 1.5 |
| 2 | 1 | 2 | 0.096 + j0.064 | 1.3 |
| 3 | 2 | 3 | 0.096 + j0.064 | 2.1 |
| 4 | 3 | 4 | 0.096 + j0.064 | 1.7 |
| 5 | 4 | 5 | 0.096 + j0.064 | 2.4 |
| 6 | 5 | 6 | 0.096 + j0.064 | 1.5 |
| 7 | 2 | 7 | 0.096 + j0.064 | 0.8 |
| 8 | 7 | 8 | 0.096 + j0.064 | 1.8 |
| 9 | 4 | 9 | 0.096 + j0.064 | 3.2 |

TABLE 2

| | Output power of distributed | | | |
|---|---|---|---|---|
| Node | power supply | | Load powers of node | |
| number | P_{G}/(MW) | Q_{G}/(MVAR) | Pₗ/(MW) | Qₗ/(MVAR) |
| 1 | 2.5 | 1.2 | 0.22 | 0 |
| 2 | 2.2 | 1.3 | 1.4 | 0 |
| 3 | 1.9 | 1.1 | 1.3 | 0 |
| 4 | 2.0 | 1.2 | 1.58 | 0 |
| 5 | 2.1 | 1.2 | 1.63 | 0 |
| 6 | 2.2 | 1.0 | 1.26 | 0 |
| 7 | 2.5 | 1.2 | 1.39 | 0 |
| 8 | 2.0 | 1.2 | 1.48 | 0 |
| 9 | 2.2 | 1.0 | 0.7 | 0 |

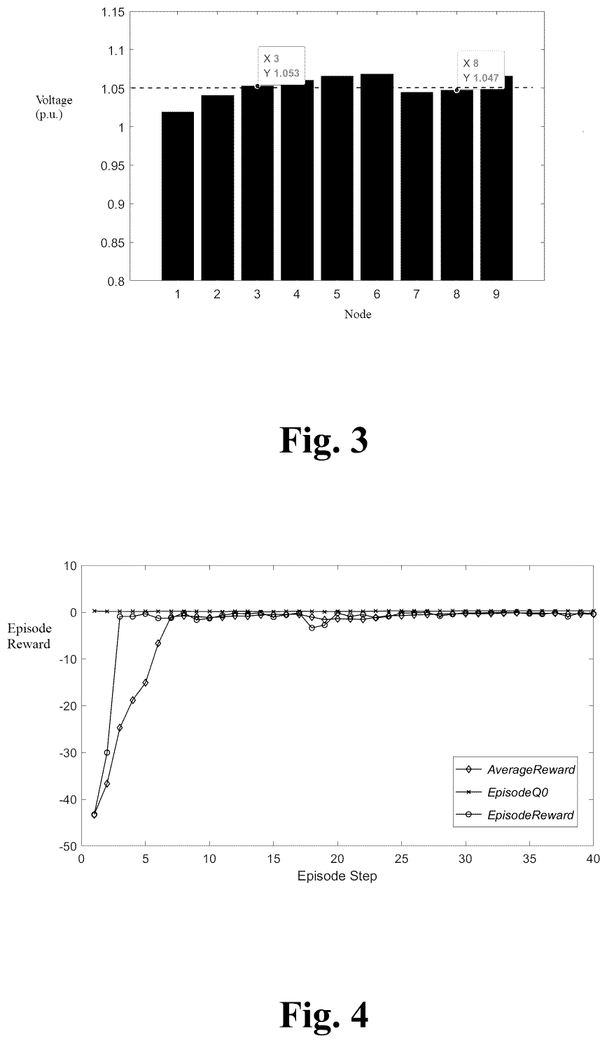

The voltage of a test platform is controlled by the method provided by the invention, and node voltages shown in FIG. 3 are obtained by monitoring. It can be known from FIG. 3 that overvoltage happens to the distribution network. The sensitivity to reactive power of the voltage obtained by calculation is shown in FIG. 3 which illustrates the sensitivity to the reactive power of the voltage of each node according to one embodiment of the invention.

TABLE 3

| | Uᵢ(10⁻⁴ | | | | | | | | |
|---|---|---|---|---|---|---|---|---|---|
| Qᵢ | U₁ | U₂ | U₃ | U₄ | U₅ | U₆ | U₇ | U₈ | U₉ |
| Q₁ | 0.1280 | 0.1280 | 0.1280 | 0.1280 | 0.1280 | 0.1280 | 0.1280 | 0.1280 | 0.1280 |
| Q₂ | 0.1280 | 0.3136 | 0.3136 | 0.3136 | 0.3136 | 0.3136 | 0.3136 | 0.3136 | 0.3136 |
| Q₃ | 0.1280 | 0.3136 | 0.4736 | 0.4736 | 0.4736 | 0.4736 | 0.3136 | 0.3136 | 0.4736 |
| Q₄ | 0.1280 | 0.3136 | 0.4736 | 0.5952 | 0.5952 | 0.5952 | 0.3136 | 0.3136 | 0.5952 |
| Q₅ | 0.1280 | 0.3136 | 0.4736 | 0.5952 | 0.8000 | 0.8000 | 0.3136 | 0.3136 | 0.5952 |
| Q₆ | 0.1280 | 0.3136 | 0.4736 | 0.5952 | 0.8000 | 0.9600 | 0.3136 | 0.3136 | 0.5952 |
| Q₇ | 0.1280 | 0.3136 | 0.3136 | 0.3136 | 0.3136 | 0.3136 | 0.4608 | 0.4608 | 0.3136 |
| Q₈ | 0.1280 | 0.3136 | 0.3136 | 0.3136 | 0.3136 | 0.3136 | 0.4608 | 0.6656 | 0.3136 |
| Q₉ | 0.1280 | 0.3136 | 0.4736 | 0.5952 | 0.5952 | 0.5952 | 0.3136 | 0.3136 | 0.8128 |

It can be known from Table 3 that node 6 has the maximum the voltage sensitivity, so a capacitor bank is connected in parallel to node 6. Assume a historical maximum voltage violation is 0.2 KV, the maximum compensation quantity of the capacitor bank is about 0.3 Mvar. A DQN intelligent agent is trained to obtain the training effect approximate to the average reward and Q value shown in FIG. 4.

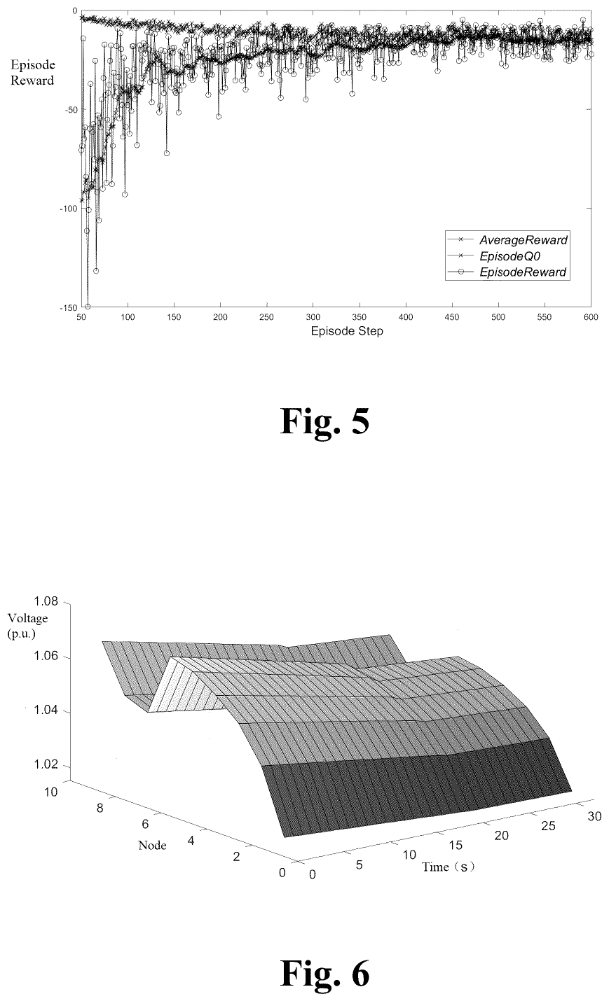

Similarly, in case of the DDPG algorithm, assume upper and lower limits of the active power output by the distributed power supplies are 3.2 MW and 1,8 MW respectively and upper and lower limits of the reactive power output by the distributed power supplies are 1.5 MW and 0.8 MW respectively, a DDPG intelligent agent is trained to obtain the training effect approximate to the average reward and Q value shown in FIG. 5.

In the invention, capacitor bank control under a long time scale and inverter control under a short time scale are considered comprehensively, active and reactive power outputs of the distributed power supplies are controlled by inverters to control the node voltage, and if the node voltage fails to be controlled within a stable range at 20 s, the voltage will be controlled by reactive power compensation of the capacitor bank. By a simulation test, the voltage control effect shown in FIG. 6 is obtained, and it takes 32 s to decrease the voltage from 1.069 p.u. into a safety range.

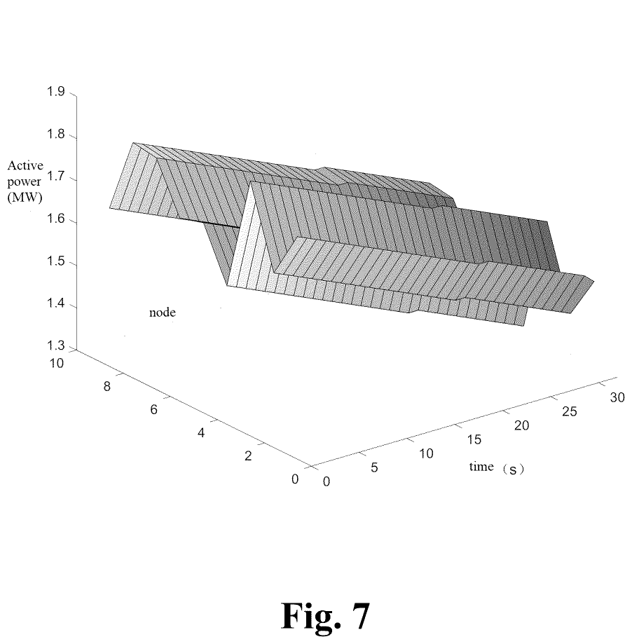

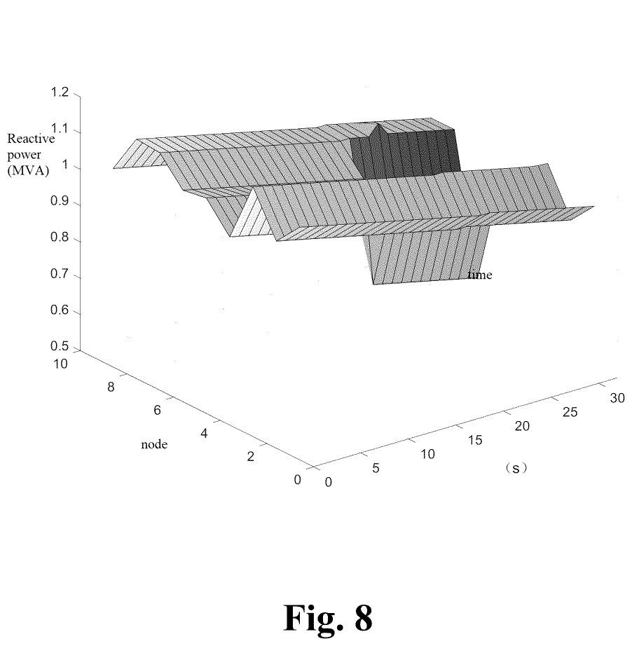

It can be known from FIG. 7 and FIG. 8 that reactive power compensation takes precedence over active power reduction, such that the loss of active power is minimized, and the reactive power is greatly decreased from 0.9485 MVA to 0.6485 MVA when DQN is used for controlling the capacitor bank. Voltage control of the capacitor bank under a long time scale and voltage control of the inverters under a short time scale are considered comprehensively, such that the voltage can be controlled into a safe and stable range in a short time, thus improving the stability of the distribution network.

Therefore, the method provided by the invention guarantees the safety of the active distribution network, solves the problem of voltage violation of the active distribution network, and has a high regulation response speed, a good voltage control effect, and certain practical engineering significance.

Although the invention has been disclosed above with reference to preferred embodiments, these embodiments are not used for limiting the invention, and all technical solutions obtained by equivalent substitution or transformation should also fall within the protection scope of the invention.

What is claimed is:

1. A multi-time scale voltage control method for an active distribution network, comprising:
calculating the sensitivity to a reactive power of a voltage of each power injection node of an active distribution network, and determining a configuration node and a configuration capacity of a capacitor bank based on the calculated sensitivity to the reactive power of the voltage;
acquiring a distribution network voltage control model in which distributed power supplies and the capacitor bank participate, which is established with a minimum voltage violation of the nodes as an objective function;
under a long time scale, converting the distribution network voltage control model in which the distributed power supplies and the capacitor bank participate into a voltage control model for controlling the capacitor bank based on the capacity of the capacitor bank on the configuration node, and solving the voltage control model for controlling the capacitor bank to obtain an optimal voltage control strategy; and
under a short time scale, converting the distribution network voltage control model in which the distributed power supplies and the capacitor bank participate into a voltage control model for controlling power outputs of the distributed power supplies, and solving the voltage control model for controlling the power outputs of the distributed power supplies to obtain an optimal voltage control strategy.

2. The multi-time scale voltage control method for an active distribution network according to claim 1, wherein the sensitivity to the reactive power of the voltage of each power injection node of the active distribution network is calculated as follows:
assuming the network has S slack nodes and N power injection bus nodes, for power injection disturbance of each individual node, setting powers of other loads/generators are not changed, and a relationship between an injected power and the voltages of the nodes is as follows:
$$\underline{{S}_{i}} = \underline{{E}_{i}} {\sum }_{j ∈ S ⋃ N} \overline{{Y}_{ij} {E}_{j}} , i ∈ N \qquad ( 3 )$$
where, E̅ⱼ̅ is the voltage of a j^{th} node, Eᵢ is a conjugate vector of E̅ᵢ̅, E̅ᵢ̅ is the voltage of an i^{th} node, Sᵢ is a conjugate vector of Sᵢ, S̅ᵢ̅ is an apparent power of the i^{th} node, and Y̅ᵢ̅ⱼ̅ is an admittance of the i^{th} node and the j^{th} node;
a slack bus satisfies:
$$\frac{\partial \overline{{E}_{i}}}{\partial {Q}_{l}} = 0 , ∀ i ∈ S \qquad ( 4 )$$
where, Qₗ is an active power of an l^{th} node,
$$\frac{\partial \overline{{E}_{i}}}{\partial {Q}_{l}}$$
is a partial derivative of the voltage of the i^{th} node with respect to a reactive power of the l^{th} node, and l=1, 2, . . . , N;
according to
$$\frac{\partial \underline{{S}_{i}}}{\partial {Q}_{l}} = \frac{\partial \{ {P}_{i} - {jQ}_{i} \}}{\partial {Q}_{l}} = - j {1}_{\{ i = 1 \}} ,$$
the partial derivative of the bus voltage with respect to the reactive power satisfies the following equations:
$$- j {1}_{\{ i = 1 \}} = \frac{\partial \underline{{E}_{i}}}{\partial {Q}_{l}} {\sum }_{j ∈ S ⋃ N} \overline{{Y}_{ij} {E}_{j}} + \underline{{E}_{i}} {\sum }_{j = N} {Y}_{ij} \frac{\partial \overline{{E}_{j}}}{\partial {Q}_{l}} i ∈ N \qquad ( 5 )$$
where, Pᵢ and Qᵢ are respectively an active power and a reactive power fed to the l^{th} node; when i=l, the right of the equation is −j; when i≠l, the right of the equation is 0;
after
$$\frac{\partial \overline{{E}_{i}}}{\partial {Q}_{l}} and \frac{\partial \underline{{E}_{i}}}{\partial {Q}_{l}}$$
are obtained by calculation according to formula (4) and formula (5), the sensitivity to the reactive power of the voltage is finally calculated according to the following formula:
$$\frac{\partial \vert \overline{{E}_{i}} \vert}{\partial {Q}_{l}} = \frac{1}{\vert \overline{{E}_{i}} \vert} Re ( \underline{{E}_{i}} \frac{\partial \overline{{E}_{i}}}{\partial {Q}_{l}} ) i ∈ N \qquad ( 6 )$$

3. The multi-time scale voltage control method for an active distribution network according to claim 2, wherein determining a configuration node and a configuration capacity of a capacitor bank based on the calculated sensitivity to the reactive power of the voltage comprises:
selecting the node with a maximum sensitivity to the reactive power as the configuration node of the capacitor bank, and calculating the capacity of the capacitor bank according to the following formula:
$$Δ {Q}_{k} = [ \vert Δ {V}_{1 , max} \vert , \vert \vert Δ {V}_{2 , max} \vert , … , \vert Δ {V}_{N , max} \vert ] \cdot [ \begin{matrix}\frac{\partial {Q}_{k}}{\partial {V}_{1}} \\ \frac{\partial {Q}_{k}}{\partial {V}_{2}} \\ ⋮ \\ \frac{\partial {Q}_{k}}{\partial {V}_{N}}\end{matrix} ] \qquad ( 7 )$$
where, ΔQₖ is the capacity of the capacitor bank on the configuration node k; |ΔV_{i,max}| is a historical maximum voltage violation of the i^{th} node, and i=1, 2, . . . , N;
$$\frac{\partial {Q}_{k}}{\partial {V}_{i}}$$
is a reciprocal of the sensitivity to a reactive power of the node k of the voltage of the i^{th} node.

4. The multi-time scale voltage control method for an active distribution network according to claim 1, wherein the objective function of the distribution network voltage control model in which the distributed power supplies and the capacitor bank participate is:
$$min F ( x ) = \{ \begin{matrix}{\sum }_{i = 1}^{n} ( {U}_{i} - 1.05 {U}_{N} ) , & {U}_{i} \geq 1.05 {U}_{N} \\ {\sum }_{i = 1}^{n} ( 0.95 {U}_{N} - {U}_{i} ) , & {U}_{i} \leq 0.95 {U}_{N}\end{matrix} \qquad ( 8 )$$
where, Uᵢ is the node voltage of an i^{th} node, U_{N} is a rated voltage of the distribution network, n is the number of power injection nodes, and a maximum safety range of the node voltage is ±5%;
constrains are:
$$\{ \begin{matrix}{\sum }_{i = 1}^{n} {P}_{t , i , l} + {P}_{t , loss} = {P}_{t , M} + {P}_{t , G} \\ {\sum }_{i = 1}^{n} {Q}_{t , i , l} + {Q}_{t , loss} = {Q}_{t , M} + {Q}_{t , G} + {Q}_{t , CB}\end{matrix} \qquad ( 9 )$$
$$\{ \begin{matrix}{U}_{i , min} \leq {U}_{i} \leq {U}_{i , max} \\ \vert \frac{{U}_{i} - {U}_{N}}{{U}_{N}} \vert \leq 5 \%\end{matrix} \qquad ( 10 )$$
$$\{ \begin{matrix}{P}_{i} = {P}_{Gi} - {P}_{li} \\ {Q}_{i} = {Q}_{Gi} - {Q}_{li} \\ {P}_{i , min} \leq {P}_{i} \leq {P}_{i , max} \\ {Q}_{i , min} \leq {Q}_{i} \leq {Q}_{i , max}\end{matrix} \qquad ( 11 )$$
$$\{ \begin{matrix}{P}_{Gi , min} \leq {P}_{Gi} \leq {P}_{Gi , max} \\ {Q}_{Gi , min} \leq {Q}_{Gi} \leq {Q}_{Gi , max}\end{matrix} \qquad ( 12 )$$
where, formula (9) is a power flow constraint, P_{t,i,l} and Q_{t,i,l} are respectively an active power and a reactive power of the i^{th} node at a time t, P_{t,loss} and Q_{t,loss} are respectively an active loss and a reactive loss of a distribution network line at the time t, P_{i,M} and Q_{t,M} are respectively an active power and a reactive power output by a main network at the time t, P_{t,G} and Q_{t,G} are respectively an active power and a reactive power output by the distributed power supplies at the time t, and Q_{t,CB} is a reactive power output by the capacitor bank at the time t; formula (10) is a node voltage constraint, U_{i,min} and U_{i,max} are respectively a maximum voltage and a minimum voltage of the i^{th} node, and Uᵢ and U_{N} are respectively the voltage of the i^{th} node and a rated voltage of the distribution network; formula (11) is a node power constraint, Pᵢ and Qᵢ are respectively an active power and a reactive power fed to the i^{th} node, P_{Gi} and Q_{Gi} are respectively an active power output and a reactive power output of the distributed power supply incorporate to the i^{th} node, Pₗᵢ and Qₗᵢ are respectively load powers on the i^{th} node, and P_{i,min}, P_{i,max}, Q_{i,min} and Q_{i,max} are respectively a minimum active power, a maximum active power, a minimum reactive power and a maximum reactive power of the i^{th} node; formula (12) is a power output constraint of the distributed power supplies, and P_{Gi,min}, P_{Gi,max}, Q_{Gi,min} and Q_{Gi,max} are respectively a minimum active power output, a maximum active power output, a minimum reactive power output and a maximum reactive power output of the distributed power supply incorporate to the i^{th} node.

5. The multi-time scale voltage control method for an active distribution network according to claim 1, wherein converting the distribution network voltage control model in which the distributed power supplies and the capacitor bank participate into a voltage control model for controlling the capacitor bank based on the capacity of the capacitor bank on the configuration node comprises:
defining a state space as a set of a current voltage, active power and reactive power of each power injection node;
determining a compensation quantity of the parallel capacitor bank on the configuration node according to the capacity of the capacitor bank, and setting an action space as the compensation quantity of the parallel capacitor bank on the configuration node; and
setting a reward function as the sum of a quadratic form of a voltage violation of each node and the compensation quantity of the capacitor bank.

6. The multi-time scale voltage control method for an active distribution network according to claim 5, wherein the state space is:
$$s : \{ {v}_{1} , … , {v}_{i} , … , {v}_{n} , {p}_{1} , … , {p}_{i} , … , {p}_{n} , {q}_{1} , … , {q}_{i} , … , {q}_{n} \} \qquad ( 13 )$$
where, vᵢ, pᵢ and qᵢ are respectively an observed voltage, active power and reactive power of an i^{th} node, i=1, 2, . . . , n, and n is the total number of the power injection nodes;
a multi-stage capacitor bank is adopted, the obtained capacity of the capacitor bank is taken as a maximum compensation quantity, and the capacity of each stage is taken as a set value of the action space:
$$A = \{ {CB}_{max} , {CB}_{max} / 2 , 0 , - {CB}_{max} / 2 , {CB}_{max} \} \qquad ( 14 )$$
where, CBₘₐₓ is the maximum compensation quantity of the capacitor bank;
the reward function is:
$$Reward = - [ Δ {v}_{1} , … , Δ {v}_{i} , … , Δ {v}_{n} ] {Q [ Δ {v}_{1} , … , Δ {v}_{i} , … , Δ {v}_{n} ]}^{T} - {Ra}_{k} \qquad ( 15 )$$
where, Δvᵢ is the voltage violation of the i^{th} node, aₖ is the compensation quantity of the capacitor bank on the configuration node k, Q and R are a weight matrix and a weight coefficient, and Δvᵢ is specifically:
$$Δ {v}_{i} = \{ \begin{matrix}{v}_{i} - {v}_{n} \times 5 \% , & {v}_{i} > ( 1 + 5 \% ) {v}_{n} \\ {v}_{n} \times 95 \% - {v}_{i} , & {v}_{i} < ( 1 - 5 \% ) {v}_{n}\end{matrix} \} \qquad ( 16 )$$
where, a selected voltage violation safety range is 5%.

7. The multi-time scale voltage control method for an active distribution network according to claim 6, wherein solving the voltage control model for controlling the capacitor bank to obtain an optimal voltage control strategy comprises:
Step a1: initializing a memory, initializing a weight parameter of a Q network to ω, initializing a weight parameter of target Q network ω′=ω, and taking the current voltage, active power and reactive power of each node as an initial state s;
Step a2: generating and performing an action a∈A according to a greedy strategy, and obtaining a reward r and a new state s′ by formula (15);
Step a3: saving a transition sample (s,a,r,s′) in the memory, and randomly selecting a minibatch of samples (sᵢ,aᵢ,rᵢ,s′ᵢ) from the memory;
Step a4: setting
$$TargetQ = {r}_{i} + γ {max}_{{a}^{′}} Q ( {s}^{′} , {a}^{′} ; {ω}^{′} ) ,$$
and calculating a loss function according to the following formula:
$$L ( θ ) = E [ {( TargetQ - Q ( s , α ; ω ) )}^{2} ] \qquad ( 17 )$$
where, E(⋅) is a desired value, TargetQ is a target value of the target network, Q(s,a;ω) is a predicted value of the action a adopted in the state s when the weight parameter is ω, and γ is a discount factor;
Step a5: updating the weight parameter of the target Q network ω′=ω by a gradient descent method; and
Step a6: repeating Step a2 to Step a5 until iteration is ended to obtain the optimal voltage control strategy.

8. The multi-time scale voltage control method for an active distribution network according to claim 1, wherein converting the distribution network voltage control model in which the distributed power supplies and the capacitor bank participate into a voltage control model for controlling power outputs of the distributed power supplies comprises:
setting a state space as a current voltage, active power and reactive power of each power injection node; setting an action space as an active power output variation and a reactive power output variation of the distributed power supply incorporated into each node; setting a reward function as the sum of a quadratic form of a voltage violation of each node and a control quantity of the distributed power supply, and setting reactive weight coefficients to be greater than active weight coefficients.

9. The multi-time scale voltage control method for an active distribution network according to claim 8, wherein the action space is the active power output variation ΔP and the reactive power output variation ΔQ of the distributed power supply incorporated into each node, ΔP∈[P_{i,max}−P_{Gi}, P_{i,min}−P_{Gi}], and ΔQ∈[Q_{i,max}−Q_{Gi}, Q_{Gi}−Q_{i,min}], where i=1, 2, . . . , n; P_{i,min}, P_{i,max}, Q_{i,min} and Q_{i,max} ax are respectively a minimum active power, a maximum active power, a minimum reactive power and a maximum reactive power of an i^{th} node; P_{Gi} and Q_{Gi} are respectively an active power output and a reactive power output of the distributed power supply incorporated into the i^{th} node;
the reward function is:
$$Reward = - [ Δ {v}_{1} , … , Δ {v}_{i} , … , Δ {v}_{n} ] {Q [ Δ {v}_{1} , … , Δ {v}_{i} , … , Δ {v}_{n} ]}^{T} - [ {p}_{1} , … , {p}_{i} , … , {p}_{n} ] {R [ {p}_{1} , … , {p}_{i} , … , {p}_{n} ]}^{T} - [ {q}_{1} , … , {q}_{i} , … , {q}_{n} ] {J [ {q}_{1} , … , {q}_{i} , … , {q}_{n} ]}^{T} \qquad ( 18 )$$
where, Δvᵢ is the voltage violation of the i^{th} node, pᵢ is the active power output of the distributed power supply incorporated into the i^{th} node, qᵢ is the active power output of the distributed power supply incorporated into the i^{th} node, and Q, R and J are weight matrixes.

10. The multi-time scale voltage control method for an active distribution network according to claim 9, wherein solving the voltage control model for controlling the power outputs of the distributed power supplies to obtain an optimal voltage control strategy comprises:
Step b1: initializing parameters of main networks and target networks, initializing a memory, and taking a current voltage, active power and reactive power of each node as an initial state;
Step b2: selecting an action according to a behavioral strategy, issuing the action to an environment to be performed, and obtaining a reward and a new state according to formula (18);
Step b3: saving a state transition process obtained in Step b2 in the memory, and randomly sampling transition data from the memory as training data of a strategy main network and an evaluation main network;
Step b4: updating parameters of the evaluation main network by a gradient descent method, and softupdating the parameters of the main target networks to the target networks by a runningaverage method; and
Step b5: repeating Step b2 to Step b4 until iteration is ended to obtain the optimal voltage control strategy.
